(19) United States
(12) Patent Application Publication
(10) Pub. No.: US 2019/0245180 A1
(43) Pub. Date: Aug. 8, 2019

(54) SEPARATOR AND SECONDARY BATTERY INCLUDING THE SEPARATOR

(71) Applicant: Sumitomo Chemical Company, Limited, Tokyo (JP)

(72) Inventors: Takahiro OKUGAWA, Niihama-shi, Ehime (JP); Tomoaki OZEKI, Niihama-shi, Ehime (JP)

(21) Appl. No.: 16/344,085

(22) PCT Filed: Oct. 24, 2016
(86) PCT No.: PCT/JP2016/081496

§ 371 Date: Apr. 23, 2019

(51) Int. Cl. H01M 2/16; C08L 23/06; C08J 9/26

(52) U.S. Cl. CPC H01M 2/1653; H01M 2/1686; C08L 23/06; C08J 9/26; C08J 2201/0444; C08L 2201/08; C08L 2203/20; C08J 2323/06; C08J 2491/06; C08L 2207/068

(57) ABSTRACT

Provided is a separator including a first layer which consists of a porous polyolefin and a secondary battery utilizing the separator. A first layer exhibits a minimum height equal to or more than 50 cm and equal to or less than 150 cm when a ball having a diameter of 14.3 mm and a weight of 11.9 g located over the first layer is allowed to free fall causing a split in the first layer. A tearing strength of the first layer in a width direction, measured with an Elmendorf tearing method, is equal to or more than 1.5 mN/μm. A tensile elongation of the first layer is equal to or longer than 0.5 mm until a load decreases to 25% of a maximum load in a load-elongation curve in machine direction measured by a rectangular tearing method.

### FIELD

An embodiment of the present invention relates to a separator and a secondary battery including the separator. For example, an embodiment of the present invention relates to a separator capable of being used in a nonaqueous electrolyte-solution secondary battery and a nonaqueous electrolyte-solution secondary battery including the separator.

### BACKGROUND

As a typical example of a nonaqueous electrolyte-solution secondary battery, a lithium ion secondary battery is represented. Since a lithium-ion secondary battery has a high energy density, it has been widely used in electronic devices such as a personal computer, a mobile phone, and a mobile information terminal. A lithium ion secondary battery includes a positive electrode, a negative electrode, an electrolyte solution charged between the positive electrode and the negative electrode, and a separator. The separator separates the positive electrode and the negative electrode from each other and also functions as a film transmitting the electrolyte solution and carrier ions. For example, patent literature 1 and 2 disclose a separator including a polyolefin.

### CITATION LIST

### Patent Literature

Patent Literature 1: Japanese Patent Application Publication No. 2012-227066

Patent Literature 2: International Patent Application Publication No. 2015-125712

### SUMMARY

An object of the present invention is to provide a separator capable of being used in a secondary battery such as a nonaqueous electrolyte-solution secondary battery and a secondary battery including the separator. Alternatively, an object of the present invention is to provide a separator capable of producing a secondary battery with high safety and reliability at a good yield and a secondary battery including the separator.

An embodiment of the present invention is a separator including a first layer which consists of a porous polyolefin. The first layer exhibits a minimum height equal to or more than 50 cm and equal to or less than 150 cm when a ball having a diameter of 14.3 mm and a weight of 11.9 g located over the first layer is allowed to freely fall causing a split in the first layer, has a tearing strength in a width direction, measured with an Elmendorf tearing method, equal to or more than 1.5 mN/μm, and has a tensile elongation equal to or longer than 0.5 mm until a load decreases to 25% of a maximum load in a load-elongation curve in machine direction measured by a rectangular tearing method.

### Effects of Invention

According to the present invention, it is possible to provide a separator which not only possesses an excellent slip property and trimming processability but also enables production of a highly safe and reliable secondary battery in which an internal short-circuit hardly occurs even if receiving an impact from the exterior as well as a secondary battery including the separator.

### BRIEF DESCRIPTION OF DRAWINGS

FIG. 1A and FIG. 1B are respectively schematic cross-sectional views of a secondary battery and a separator according to an embodiment of the present invention;

FIG. 2 shows a calculation method of a tensile elongation.

FIG. 3 A to FIG. 3C are drawings showing the tools used in the falling-ball test;

FIG. 4A and FIG. 4B are drawings showing an evaluation method of trimming processability;

FIG. 5A and FIG. 5B are respectively a bottom view and a side view of a sledge for measuring a pin-extracting resistance; and

FIG. 6 is a drawing showing a measuring method of the pin-extracting resistance.

### DESCRIPTION OF EMBODIMENTS

Hereinafter, the embodiments of the present invention are explained with reference to the drawings and the like. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention.

In the specification and the claims, unless specifically stated, when a state is expressed where a structure is arranged “on” another structure, such an expression includes both a case where the substrate is arranged immediately above the “other structure” so as to be in contact with the “other structure” and a case where the structure is arranged over the “other structure” with an additional structure therebetween.

In the specification and the claims, an expression “substantially including only A” includes a state where no substance is included other than A, a state where A and an impurity are included, and a state misidentified as a state where a substance other than A is included due to a measurement error. When this expression means the state where A and an impurity are included, there is no limitation to the kind and concentration of the impurity.

### First Embodiment

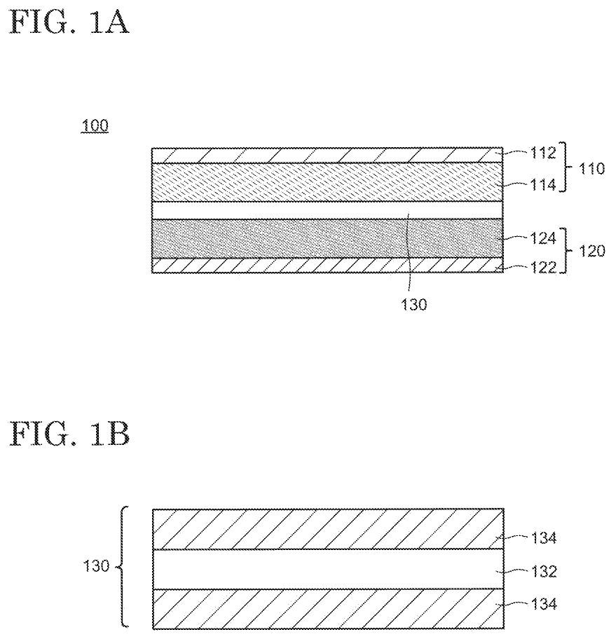

A schematic cross-sectional view of a secondary battery 100 according to an embodiment of the present invention is shown in FIG. 1A. The secondary battery 100 includes a positive electrode 110, a negative electrode 120, and a separator 130 separating the positive electrode 110 and the negative electrode 120 from each other. Although not illustrated, the secondary battery 100 possesses an electrolyte solution 140. The electrolyte solution 140 mainly exists in apertures of the positive electrode 110, the negative electrode 120, and the separator 130 as well as in the gaps between these members. The positive electrode 110 may include a positive-electrode current collector 112 and a positive-electrode active-substance layer 114. Similarly, the negative electrode 120 may include a negative-electrode current collector 122 and a negative-electrode active-substance layer 124. Although not illustrated in FIG. 1A, the secondary battery 100 further possesses a housing by which the positive electrode 110, the negative electrode 120, the separator 130, and the electrolyte solution 140 are supported.

### 1. Separator

### 1-1. Structure

The separator 130 is disposed between the positive electrode 110 and the negative electrode 120 and serves as a film having a role of separating the positive electrode 110 and the negative electrode 120 and transporting the electrolyte solution 140 in the secondary battery 100. A schematic cross-sectional view of the separator 130 is shown in FIG. 1B. The separator 130 has a first layer 132 including a porous polyolefin and may further possess a porous layer 134 as an optional structure. The separator 130 may have a structure in which two porous layers 134 sandwich the first layer 132 as shown in FIG. 1B, or a structure in which the porous layer 134 is disposed only on one surface of the first layer 132. Alternatively, a structure may be employed where no porous layer 134 is provided. The first layer 132 may have a single-layer structure or may be structured with a plurality of layers.

The first layer 132 has internal pores linked to each other. This structure allows the electrolyte solution 140 to permeate the first layer 132 and enables carrier ions such as lithium ions to be transported via the electrolyte solution 140. At the same time, physical contact between the positive electrode 110 and the negative electrode 120 is inhibited. On the other hand, when the secondary battery 100 has a high temperature, the first layer 132 melts and the pores disappear, thereby stopping the transportation of the carrier ions. This behavior is called shutdown. This behavior prevents heat generation and ignition caused by a short-circuit between the positive electrode 110 and the negative electrode 120, by which high safety is secured.

The first layer 132 includes a porous polyolefin. Alternatively, the first layer 132 may be structured with a porous polyolefin. Namely, the first layer 132 may be configured so as to include only a porous polyolefin or substantially include only a porous polyolefin. The porous polyolefin may contain an additive. In this case, the first layer 132 may be structured only with the polyolefin and the additive or substantially only with the polyolefin and the additive. When the porous polyolefin contains the additive, the polyolefin may be included in the porous polyolefin at a composition equal to or higher than 95 wt % or equal to or higher than 97 wt %. Furthermore, the polyolefin may be included in the first layer 132 at a composition equal to or higher than 95 wt % or equal to or higher than 97 wt %. As the additive, an organic compound (organic additive) is represented, and the organic compound may be an antioxidant (organic antioxidant) or a lubricant.

As the polyolefin structuring the porous polyolefin, a homopolymer obtained by polymerizing an α-olefin such as ethylene, propylene, 1-butene, 4-methyl-1-pentene, and 1-hexene or a copolymer thereof is represented. A mixture of these homopolymers and copolymers may be included in the first layer 132. The organic additive may have a function to prevent oxidation of the polyolefin, and phenols or phosphoric esters may be employed as the organic additive, for example. Phenols having a bulky substituent at an α-position and/or a β-position of a phenolic hydroxy group may be also used.

As a typical polyolefin, a polyethylene-based polymer is represented. When a polyethylene-based polymer is used, a low-density polyethylene or a high-density polyethylene may be used. Alternatively, a copolymer of ethylene with an α-olefin may be used. These polymers or copolymers may be a high-molecular weight polymer with a weight-average molecular weight equal to or higher than 100,000 or an ultrahigh-molecular weight polymer with a weight-average molecular weight of equal to or higher than 1,000,000. The use of a polyethylene-based polymer enables the shutdown function to be realized at a lower temperature, thereby providing high safety to the secondary battery 100.

A thickness of the first layer 132 may be equal to or larger than 4 μm and equal to or smaller than 40 μm, equal to or larger than 5 μm and equal to or smaller than 30 μm, or equal to or larger than 6 μm and equal to or smaller than 15 μm.

A weight per unit area of the first layer 132 is appropriately determined in view of its strength, thickness, weight, and handleability. For example, the weight per unit area may be equal to or more than 4 g/m² and equal to or less than 20 g/m², equal to or more than 4 g/m² and equal to or less than 12 g/m², or equal to or more than 5 g/m² and equal to or less than 10 g/m², by which a weight-energy density and a volume-energy density of the secondary battery 100 can be increased. Note that a weight per unit area is a weight per unit area.

With respect to gas permeability of the first layer 132, its Gurley value may be selected from a range equal to or higher than 30 s/100 mL and equal to or lower than 500 s/100 mL or equal to or higher than 50 s/100 mL and equal to or lower than 300 s/100 mL so that sufficient ion-permeability can be obtained.

A porosity of the first layer 132 may be selected from a range equal to or more than 20 vol % and equal to or less than 80 vol %, equal to or more than 20 vol % and equal to or less than 75 vol %, equal to or more than 20 vol % and equal to or less than 55 vol %, equal to or more than 30 vol % and equal to or less than 55 vol %, or equal to or more than 40 vol % and equal to or less than 55 vol % so that a retention volume of the electrolyte solution 140 is increased and the shutdown function is surely realized. A diameter of the pore (average pore diameter) in the first layer 132 may be selected from a range equal to or larger than 0.01 μm and equal to or smaller than 0.3 μm or equal to or larger than 0.01 μm and equal to or smaller than 0.14 μm so that a sufficient ion-permeability and a high shutdown function can be obtained.

### 1-2. Property

The first layer 132 exhibits a minimum height (hereinafter, referred to as a minimum height hₘᵢₙ) of a ball in a falling-ball test equal to or more than 50 cm and equal to or less than 150 cm. Moreover, a tearing strength (hereinafter, referred to as a tearing strength T) of the first layer 132 in a width direction (also called a transverse direction. Hereinafter, referred to as a TD.) measured with an Elmendorf tearing method is equal to or more than 1.5 mN/μm, equal to or more than 1.75 mN/μm, or equal to or more than 2.0 mN/μm and equal to or less than 10 mN/μm or equal to or less than 4.0 mN/μm, and a tensile elongation (hereinafter, referred to as a tensile elongation E) thereof is equal to or longer than 0.5 mm, equal to or longer than 0.75 mm, or equal to or longer than 1.0 mm and equal to or shorter than 10 mm until a load decreases to 25% of a maximum load in a load-elongation curve in a machine direction (also called a flow direction. Hereinafter, referred to as a MD.) obtained by a rectangular tearing method.

When a polymer material is rolled and stretched, a brittle skin layer having a high orientation property is formed at a surface thereof. In addition, a difference in direction is generated between the TD and the MD during rolling and stretching. The inventors found that the proportion of the skin layer is low and the difference in orientation between the MD and the TD is small in the separator 130 including the first layer 132 with the minimum height hₘᵢₙ, the tearing strength T, and the tensile elongation E respectively falling within the aforementioned ranges. It was also found that the separator 130 shows an excellent slip property and trimming processability due to these properties, which allows a secondary battery to be produced in a short takt time at a high yield. Moreover, it was proven that the use of the separator 130 enables production of the secondary battery 200 having excellent dielectric-breakdown resistance. Hence, it is possible to provide the secondary battery 100 with high safety and reliability in which an internal short-circuit hardly occurs even if receiving an impact from the exterior. The properties described above are explained below.

In the specification and claims, the falling-ball test is an evaluation test conducted as follows. A mirror-surface ball with a diameter of 14.3 mm and a weight of 11.9 g is subjected to a free fall on the first layer 132 from a height h. The height h is a distance between the ball immediately prior to the free fall and the first layer 132. The minimum height value of h which causes a split in the first layer 132 when the ball falls on the first layer 132 is the lowest value of the ball. Note that it is necessary to thicken the first layer 132 or reduce porosity in order to increase the minimum height to be more than 150 cm. However, an increase in thickness reduces energy density of the secondary battery, and a decrease in porosity causes a decrease in battery performance. Hence, it is preferred that the minimum height be equal to or less than 150 cm.

In the specification and claims, the tensile strength is a tearing force measured according to “JIS K 7128-2 Tearing Strength Test Method of Plastic Film and Sheet-2nd Part: Elmendorf Tearing Method” regulated by the Japan Industrial Standards (JIS). Specifically, the tearing force is measured using the separator 130 having a rectangular shape based on the JIS Regulation where the swing angle of a pendulum is set to be 68.4° and the tearing direction in the measurement is set in the TD of the separator 130. The measurement is carried out in a state where 4 to 8 separators are stacked, and the obtained tearing load is divided by the number of the measured separators to calculate the tearing strength per one separator 130. The tearing strength per one separator 130 is further divided by the thickness of the separator 130 to calculate the tearing strength T per 1 μm thickness of the separator 130.

That is, the tearing strength T is calculated by the following equation.

T=(F/d)

where F is the tearing load (mN) per one separator 130 obtained by the measurement, d is the thickness (μm) of the separator 130, and the unit of the tearing strength T is mN/μm.

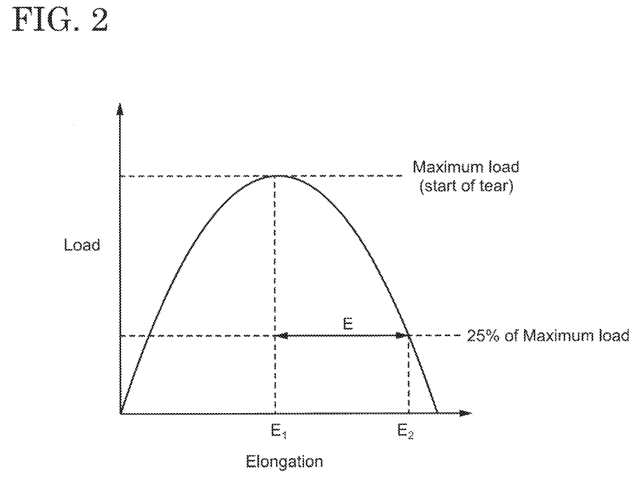

In the specification and claims, the tensile elongation E is an elongation of the separator 130 calculated from the load-elongation curve obtained by the measurement based on the “JIS K 7128-3 Tearing Strength Test Method of Plastic Film and Sheet-3rd Part: Rectangular Tearing Method” regulated by the JIS. The separator 130 is processed into the shape based on the JIS Regulation and is stretched at an elongating rate of 200 mm/min while arranging the tearing direction in the TD. Since the stretching direction and the tearing direction are reversed, the stretching direction is the MD, while the tearing direction is the TD. That is, the separator 130 becomes a shape long in the MD. The load-elongation curve obtained by the measurement under these conditions is schematically shown in FIG. 2. The tensile elongation E is an elongation (E₂−E₁) from the time when the load applied to the separator 130 reaches a maximum (when the maximum load is applied) until the time when the load applied to the separator 130 decreases to 25% of the maximum load.

The separator 130 is configured to have the minimum height hₘᵢₙ, the tearing strength T, and the tensile elongation E in the aforementioned ranges by which the proportion of the skin layer can be reduced in the separator 130. Since the skin layer has a physically brittle property, reduction in the proportion of the skin layer makes it difficult to tear the separator 130 and increases the tearing strength T. Simultaneously, the difference in orientation between the MD and the TD (e.g., difference in crystal orientation) can be decreased. When the orientation difference is large, the separator 130 is readily teared in the MD or TD, and an impact from the exterior triggers a tear in the direction which is fragile to tearing. When such a tear occurs, the positive electrode 110 and the negative electrode 120 make contact with each other to cause an internal short-circuit, which results in a break of the secondary battery 100 and leads to a fire. However, the separator 130 having the minimum height hₘᵢₙ, the tearing strength T, and the tensile elongation E in the aforementioned ranges has a high strength to tearing, thereby enabling production of the highly safe and reliable secondary battery 100 which hardly undergoes an internal short-circuit.

When the secondary battery 100 is fabricated using the separator 130 including the first layer 132, the separator 130 is trimmed into a predetermined size. If a split occurs in an unintended direction during trimming, the yield of the secondary battery decreases. In addition, when a wound secondary battery is fabricated using the separator 130, the separator 130 and the electrodes (the positive electrode 110 and the negative electrode 120) are wound on a columnar member (hereinafter, referred to as a pin), and then the pin is extracted. At this time, if friction between the separator 130 and the pin is large, the pin cannot be readily extracted, thereby destroying the separator 130, the electrodes, or the pin. As a result, the manufacturing process is affected, and the yield is decreased. However, as mentioned above, the separator 130 according to the present embodiment has the minimum height hₘᵢₙ, the tearing strength T, and the tensile elongation E in the aforementioned ranges and is excellent in orientation balance between the MD and TD. Hence, it is possible to selectively cut the separator 130 in the intended direction. Moreover, a friction with other members is the same between the MD and the TD due to the excellent orientation balance. For example, the friction with other members such as a pin used in fabricating the secondary battery 100 can be reduced. Thus, the manufacturing yield is improved, and the manufacturing takt time can be reduced.

### 2. Electrode

As described above, the positive electrode 110 may include the positive-electrode current collector 112 and the positive-electrode active-substance layer 114. Similarly, the negative electrode 120 may include the negative-electrode current collector 122 and the negative-electrode active-substance layer 124 (see FIG. 1A). The positive-electrode current collector 112 and the negative-electrode current collector 122 respectively possess the positive-electrode active-substance layer 114 and the negative-electrode active-substance layer 124 and have functions to supply current to the positive-electrode active-substance layer 114 and the negative-electrode active-substance layer 124, respectively.

A metal such as nickel, copper, titanium, tantalum, zinc, iron, and cobalt or an alloy such as stainless including these metals can be used for the positive-electrode current collector 112 and the negative-electrode current collector 122, for example. The positive-electrode current collector 112 and the negative-electrode current collector 122 may have a structure in which a plurality of layers including these metals is stacked.

The positive-electrode active-substance layer 114 and the negative-electrode active-substance layer 124 respectively include a positive-electrode active substance and a negative-electrode active substance. The positive-electrode active substance and the negative-electrode active substance have a role to release and absorb carrier ions such as lithium ions.

As a positive-electrode active substance, a material capable of being doped or de-doped with carrier ions is represented, for example. Specifically, a lithium-based composite oxide containing at least one kind of transition metals such as vanadium, manganese, iron, cobalt, and nickel is represented. As such a composite oxide, a lithium-based composite oxide having an α-NaFeO₂-type structure, such as lithium nickelate and lithium cobalate, and a lithium-based composite oxide having a spinel-type structure, such as lithium manganese spinel, are given. These composite oxides have a high average discharge potential.

The lithium-based composite oxide may contain another metal element and is exemplified by lithium nickelate (composite lithium nickelate) including an element selected from titanium, zirconium, cerium, yttrium, vanadium, chromium, manganese, iron, cobalt, copper, silver, magnesium, aluminum, gallium, indium, tin, and the like, for example. These metals may be adjusted to be equal to or more than 0.1 mol % and equal to or less than 20 mol % to the metal elements in the composite lithium nickelate. This structure provides the secondary battery 100 with an excellent rate property when used at a high capacity. For example, a composite lithium nickelate including aluminum or manganese and containing nickel at 85 mol % or more or 90 mol % or more may be used as the positive-electrode active substance.

Similar to the positive-electrode active substance, a material capable of being doped and de-doped with carrier ions can be used as the negative-electrode active substance. For example, a lithium metal or a lithium alloy is represented. Alternatively, it is possible to use a carbon-based material such as graphite exemplified by natural graphite and artificial graphite, cokes, carbon black, and a sintered polymeric compound exemplified by carbon fiber; a chalcogen-based to compound capable of being doped and de-doped with lithium ions at a potential lower than that of the positive electrode, such as an oxide and a sulfide; an element capable of being alloyed or reacting with an alkaline metal, such as aluminum, lead, tin, bismuth, and silicon; an intermetallic compound of cubic system (AlSb, Mg₂Si, NiSi₂) undergoing alkaline-metal insertion between lattices; lithium-nitride compound (Li₃₋ₓMₓN (M: transition metal)); and the like. Among the negative-electrode active substances, the carbon-based material including graphite such as natural graphite and artificial graphite as a main component provides a large energy density due to high potential uniformity and a low average discharge potential when combined with the positive electrode 110. For example, it is possible to use, as the negative-electrode active substance, a mixture of graphite and silicon with a ratio of silicon to carbon equal to or larger than 5 mol % and equal to or smaller 10 mol %.

The positive-electrode active-substance layer 114 and the negative-electrode active-substance layer 124 may each further include a conductive additive and binder other than the aforementioned positive-electrode active substance and the negative-electrode active substance.

As a conductive additive, a carbon-based material is represented. Specifically, graphite such as natural graphite and artificial graphite, cokes, carbon black, pyrolytic carbons, and a sintered polymeric compound such as carbon fiber are given. A plurality of materials described above may be mixed to use as a conductive additive.

As a binder, poly(vinylidene fluoride) (PVDF), polytetrafluoroethylene, poly(vinylidene fluoride-co-hexafluoropropylene), poly(tetrafluoroethylene-co-hexafluoropropylene), poly(tetrafluoroethylene-co-perfluoroalkyl vinyl ether), poly(ethylene-co-tetrafluoroethylene), a copolymer in which vinylidene fluoride is used as a monomer, such as a poly(vinylidene fluoride-co-hexafluoropropylene-co-tetrafluoroethylene), a thermoplastic resin such as a thermoplastic polyimide, polyethylene, and polypropylene, an acrylic resin, styrene-butadiene rubber, and the like are represented. Note that a binder may further have a function as a thickener.

The positive electrode 110 may be formed by applying a mixture of the positive-electrode active substance, the conductive additive, and the binder on the positive-electrode current collector 112, for example. In this case, a solvent may be used to form or apply the mixture. Alternatively, the positive electrode 110 may be formed by applying a pressure to the mixture of the positive-electrode active substance, the conductive additive, and the binder to process the mixture and arranging the processed mixture on the positive electrode 110. The negative electrode 120 can also be formed with a similar method.

### 3. Electrolyte Solution

The electrolyte solution 140 includes the solvent and an electrolyte, and at least a part of the electrolyte is dissolved in the solvent and electrically dissociated. As the solvent, water and an organic solvent can be used. In the case where the secondary battery 100 is utilized as a nonaqueous electrolyte-solution secondary battery, an organic solvent is used. As an organic solvent, carbonates such as ethylene carbonate, propylene carbonate, dimethyl carbonate, diethyl carbonate, ethyl methyl carbonate, and 1,2-di(methoxycarbonyloxy)ethane, ethers such as 1,2-dimethoxyethane, 1,3-dimethoxypropane, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone, sulfur-containing compounds such as sulfolane, dimethyl sulfoxide, and 1,3-propanesultone, a fluorine-containing organic solvent in which fluorine is introduced to the aforementioned organic solvent; and the like are represented. A mixed solvent of these organic solvents may also be employed.

As a typical electrolyte, a lithium salt is represented. For example, LiCIO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, a lithium salt of a carboxylic acid having 2 to 6 carbon atoms, LiAlCl₄, and the like are represented. Just one kind of the lithium salts mentioned above may be used, and more than two kinds of lithium salts may be combined.

Note that, in a broad sense, an electrolyte may mean a solution of an electrolyte. However, in the present specification and claims, a narrow sense is employed. That is, an electrolyte is a solid and is electrically dissociated upon dissolving in a solvent to provide an ion conductivity to the resulting solution.

### 4. Fabrication Process of Secondary Battery

As shown in FIG. 1A, the negative electrode 120, the separator 130, and the positive electrode 110 are arranged to form a stacked body. After that, the stacked body is disposed in a housing which is not illustrated. The secondary battery 100 can be fabricated by filling the housing with the electrolyte solution and sealing the housing while reducing a pressure in the housing or by sealing the housing after filing the housing with the electrolyte solution while reducing a pressure in the housing. A shape of the secondary battery 100 is not limited and may be a thin-plate (paper) form, a disc form, a cylinder form, a prism form such as a rectangular parallelepiped, or the like.

### Second Embodiment

In the present embodiment, a method for preparing the first layer 132 described in the First Embodiment is described. An explanation of the structures the same as those of the First Embodiment may be omitted.

A method for preparing the first layer 132 includes (1) a process for obtaining a polyolefin composite by kneading an ultrahigh-molecular weight polyethylene, a low-molecular weight polyethylene having a weight-average molecular weight of 10,000 or less, and a pore-forming agent, (2) a process for forming a sheet by rolling the polyolefin composite with a rolling roll (rolling process), (3) a process for removing the pore-forming agent from the sheet obtained in the process (2), and (4) a process for processing into a film state by stretching the sheet obtained in the process (3).

In the process (1), aggregates included in the polyolefin composite may be removed by conducting filtration with a metal mesh after forming the polyolefin resin, by which uniformity of the obtained first layer 132 is improved and the tearing strength T and the tensile elongation E can be controlled within the ranges described above. As a result, it is possible to prepare the separator 130 including the first layer 132 in which a local tear hardly occurs. The size of the openings of the metal mesh may be determined in view of the balance between the size of the aggregates and the filtering rate.

The pore-forming agent used in the process (1) may include an organic substance or an inorganic substance. As an organic substance, a plasticizer is represented. A low-molecular weight hydrocarbon such as a liquid paraffin is exemplified as a plasticizer.

As an inorganic substance, an inorganic material soluble in a neutral, acidic, or alkaline solvent is represented, and calcium carbonate, magnesium carbonate, barium carbonate, and the like are exemplified. Other than these materials, an inorganic compound such as calcium chloride, sodium chloride, and magnesium sulfate is represented.

In the process (3) in which the pore-forming agent is removed, a solution of water or organic solvent to which an acid or a base is to added, or the like is used as a cleaning solution. A surfactant may be added to the cleaning solution. An addition amount of the surfactant can be arbitrarily selected from a range equal to or more than 0.1 wt % to 15 wt % or equal to or more than 0.1 wt % and equal to or less than 10 wt %. It is possible to secure a high cleaning efficiency and prevent the surfactant from being left by selecting the addition amount from this range. A cleaning temperature may be selected from a temperature range equal to or higher than 25° C. and equal to or lower than 60° C., equal to or higher than 30° C. and equal to or lower than 55° C., or equal to or higher than 35° C. and equal to or lower than 50° C., by which a high cleaning efficiency can be obtained and evaporation of the cleaning solution can be avoided.

In the process (3), water cleaning may be further conducted after removing the pore-forming agent with the cleaning solution. The temperature in the water cleaning may be selected from a temperature range equal to or higher than 25° C. and equal to or lower than 60° C., equal to or higher than 30° C. and equal to or lower than 55° C., or equal to or higher than 35° C. and equal to or lower than 50° C.

In the processes (3) and (4), the sheet obtained in the process (2) may be used as a single layer, or a plurality of sheets may be stacked. The use of the sheet as a single layer more readily reduces the proportion of the skin layer, by which the minimum height hₘᵢₙ, the tearing strength T, and the tensile elongation E can be controlled within the ranges described above.

### Third Embodiment

In the present embodiment, an embodiment in which the separator 130 has the porous layer 134 in addition to the first layer 132 is explained.

### 1. Structure

As described in the First Embodiment, the porous layer 134 may be disposed on one side or both sides of the first layer 132 (see FIG. 1B). When the porous layer 134 is stacked on one side of the first layer 132, the porous layer 134 may be arranged on a side of the positive electrode 110 or on a side of the negative electrode 120 of the first layer 132.

The porous layer 134 is insoluble in the electrolyte solution 140 and is preferred to include a material chemically stable in a usage range of the second battery 100. As such a material, it is possible to represent a polyolefin such as polyethylene, polypropylene, polybutene, poly(ethylene-co-propylene); a fluorine-containing polymer such as poly(vinylidene fluoride) (PVDF), polytetrafluoroethylene, poly(vinylidene fluoride-co-hexafluoropropylene), and poly(tetrafluoroethylene-co-hexafluoropropylene); an aromatic polyamide (aramide); rubber such as poly(styrene-co-butadiene) and a hydride thereof, a copolymer of methacrylic esters, a poly(acrylonitrile-co-acrylic ester), a poly(styrene-co-acrylic ester), ethylene-propylene rubber, and poly(vinyl acetate); a polymer having a melting point and a glass-transition temperature of 180° C. or more, such as poly(phenylene ether), a polysulfone, a poly(ether sulfone), polyphenylenesulfide, a poly(ether imide), a polyamide-imide, a polyether-amide, and a polyester; a water-soluble polymer such as poly(vinyl alcohol), poly(ethylene glycol), a cellulose ether, sodium alginate, poly(acrylic acid), polyacrylamide, poly(methacrylic acid); and the like.

As an aromatic polyamide, poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylenecarboxylic amide), poly(metaphenylene-4,4′-biphenylenecarboxilic amide), poly(paraphenyelnee-2,6-natphthalenedicarboxlic amide), poly(metaphenyelnee-2,6-natphthalenedicarboxlic amide), poly(2-chloroparaphenylene terephthalamide), a copolymer of paraphenylene terephthalamide with 2,6-dichloroparaphenylene terephthalamide, a copolymer of metaphenylene terephthalamide with 2,6-dichloroparaphenylene terephthalamide, and the like are represented, for example.

The porous layer 134 may include a filler. A filler consisting of an organic substance or an inorganic substance is represented as a filler. A filler called a filling agent and consisting of an inorganic substance is preferred. A filler consisting of an inorganic oxide such as silica, calcium oxide, magnesium oxide, titanium oxide, alumina, mica, zeolite, aluminum hydroxide, boehmite, and the like is more preferred, at least one kind of filler selected from a group consisting of silica, magnesium oxide, titanium oxide, aluminum hydroxide, boehmite, and alumina is further preferred, and alumina is especially preferred. Alumina has a number of crystal forms such as α-alumina. β-alumina. γ-alumina. θ-alumina, and the like, and any of the crystal forms can be appropriately used. Among them, α-alumina is most preferable due to its particularly high thermal stability and chemical stability. Just one kind of filler may be used, or two or more kinds of filler may be combined in the porous layer 134.

No limitation is provided to a shape of the filler, and the filler may have a sphere shape, a cylindrical shape, an elliptical shape, a gourd shape, and the like. Alternatively, a filler in which these shapes are mixed may be used.

When the porous layer 134 includes the filler, an amount of the filler to be included may be equal to or larger than 1 vol % and equal to or smaller than 99 vol % or equal to or larger than 5 vol % and equal to or smaller than 95 vol % with respect to the porous layer 134. The aforementioned range of the amount of the filler to be included prevents the space formed by contact between the fillers from being closed by the material of the porous layer 134, which leads to sufficient ion permeability and allows its weight per unit area to be adjusted.

A thickness of the porous layer 134 can be selected from a range equal to or larger than 0.5 μm and equal to or smaller than 15 μm or equal to or larger than 2 μm and equal to or smaller than 10 μm. Hence, when the porous layers 134 are formed on both sides of the first layer 132, a total thickness of the porous layers 134 may be selected from a range equal to or larger than 1.0 μm and equal to or smaller than 30 μm or equal to or larger than 4 μm and equal to or smaller than 20 μm.

When the total thickness of the porous layers 134 is arranged to be equal to or larger than 1.0 μm, internal short-circuits caused by damage to the secondary battery 100 can be more effectively prevented. The total thickness of the porous layers 134 equal to or smaller than 30 μm prevents an increase in permeation resistance of the carrier ions, thereby preventing deterioration of the positive electrode 110 and a decrease in battery performance and a cycle property resulting from an increase in permeation resistance of the carrier ions. Moreover, it is possible to avoid an increase in distance between the positive electrode 110 and the negative electrode 120, which contributes to miniaturization of the secondary battery 100.

The weight per unit area of the porous layer 134 may be selected from a range equal to or more than 1 g/m² and equal to or less than 20 g/m² or equal to or more than 2 g/m² and equal to or less than 10 g/m². This range increases an energy density per weight and energy density per volume of the secondary battery 100.

A porosity of the porous layer 134 may be equal to or more than 20 vol % and equal to or less than 90 vol % or equal to or more than 30 vol % and equal to or less than 80 vol %. This range allows the porous layer 134 to have sufficient ion permeability. An average porous diameter of the pores included in the porous layer 134 may be selected from a range equal to or larger than 0.01 μm and equal to or smaller than 1 μm or equal to or larger than 0.01 μm and equal to or to smaller than 0.5 μm, by which a sufficient ion permeability is provided to the secondary battery 100 and the shutdown function can be improved.

A gas permeability of the separator 130 including the aforementioned first layer 132 and the porous layer 134 may be equal to or higher than 30 s/100 mL and equal to or lower than 1000 s/100 mL or equal to or higher than 50 s/100 mL and equal to or lower than 800 s/100 L in a Gurley value, which enables the separator 130 to have sufficient strength, maintain a high shape stability at a high temperature, and possess sufficient ion permeability.

### 2. Preparation Method

When the porous layer 134 including the filler is prepared, the aforementioned polymer or resin is dissolved or dispersed in a solvent, and then the filler is dispersed in this mixed liquid to form a dispersion (hereinafter, referred to as a coating liquid). As a solvent, water; an alcohol such as methyl alcohol, ethyl alcohol, n-propyl alcohol, isopropyl alcohol, and t-butyl alcohol; acetone, toluene, xylene, hexane, N-methylpyrrolidone, N,N-dimethylacetamide, N,N-dimethylformamide; and the like are represented. Just one kind of solvent may be used, or two or more kinds of solvents may be used.

When the coating liquid is prepared by dispersing the filler to the mixed liquid, a mechanical stirring method, an ultrasonic dispersing method, a high-pressure dispersion method, a media dispersion method, and the like may be applied. In addition, after the filler is dispersed in the mixed liquid, the filler may be subjected to wet milling by using a wet-milling apparatus.

An additive such as a dispersant, a plasticizer, a surfactant, or a pH-adjusting agent may be added to the coating liquid.

After the preparation of the coating liquid, the coating liquid is applied on the first layer 132. For example, the porous layer 134 can be formed over the first layer 132 by directly coating the first layer 132 with the coating liquid by using a dip-coating method, a spin-coating method, a printing method, a spraying method, or the like and then removing the solvent. Instead of directly applying the coating liquid over the first layer 132, the porous layer 134 may be transferred onto the first layer 132 after being formed on another supporting member. As a supporting member, a film made of a resin, a belt or drum made of a metal may be used.

Any method selected from natural drying, fan drying, heat drying, and vacuum drying may be used to remove the solvent. Drying may be conducted after substituting the solvent with another solvent (e.g., a solvent with a low boiling point). When heating, drying may be carried out at 10° C. or higher and 120° C. or lower or at 20° C. or higher and 80° C. or lower. This temperature range avoids a reduction in gas permeability caused by shrinkage of the pores in the first layer 132.

A thickness of the porous layer 134 can be controlled by a thickness of the coating film in a wet state after coating, an amount of the filler included, a concentration of the polymer and the resin, and the like.

### EXAMPLES

### 1. Preparation of Separator

An example for preparing the separator 130 is described below.

### 1-1. Example 1

To a mixture of 68 wt % of ultrahigh-molecular weight polyethylene powder (GUR2024 manufactured by Ticona) and 32 wt % of polyethylene wax (FNP-0115, manufactured by Nippon Seiro Co. Ltd.) having a weight-average molecular weight of 1000, 0.4 weight portions of an antioxidant (Irg1010, manufactured by CIBA Speciality Chemicals), 0.1 weight portions of an antioxidant (P168 manufactured by CIBA Speciality Chemicals®), and 1.3 weight portions of sodium stearate with respect to 100 weight portions of the summation of the ultrahigh-molecular weight polyethylene and the polyethylene wax were added, and calcium carbonate (manufactured by Maruo Calcium Co. LTD.) with an average particle diameter of 0.1 μm was further added as the pore-forming agent so that its proportion to the entire volume is 38 vol %. After these materials were mixed in a power state with a Henschel mixer, the mixture was kneaded while being melted, and then filtered with a 300-mesh metal mesh to obtain a polyolefin-resin composite. This mixture was rolled using three rolling rollers R1, R2, and R3 having a surface temperature of 150° C., where a first rolling was carried out using the rollers R1 and R2 while a second rolling was carried out using the rollers R2 and R3. The mixture was cooled stepwise while being drawn with a winding roller different in speed from the rolling rollers (drawing ratio (winding speed/rolling speed)=1.4), resulting in a sheet with a thickness of 64 μm. This sheet was dipped in hydrochloric acid (4 mol/L) including 0.5 wt % of a nonionic surfactant to remove calcium carbonate and sequentially stretched to 6.2 times at 100° C. to obtain the separator 130.

### 1-2. Example 2

The separator 130 was obtained with the same method as the Example 1 except that 70 wt % of the ultrahigh-molecular weight polyethylene powder was used, 30 wt % of the polyethylene wax was used, 36 vol % of the calcium carbonate was used, the composite kneaded with a twin-screw kneader while being melted was filtered with a 200-mesh metal mesh to obtain the polyolefin-resin composite, the polyolefin-resin composite was rolled with a pair of roller of 150° C. instead of the rolling rollers R1, R2, and R3, and the polyolefin-resin composite was stretched at 105° C. The thickness of the sheet was 67 μm.

### 1-3. Comparative Example 1

To a mixture of 70 wt % of ultrahigh-molecular weight polyethylene powder (GUR4032 manufactured by Ticona) and 30 wt % of polyethylene wax (FNP-0115, manufactured by Nippon Seiro Co. Ltd.) having a weight-average molecular weight of 1000, 0.4 weight portions of an antioxidant (Irg1010, manufactured by CIBA Speciality Chemicals), 0.1 weight portions of an antioxidant (P168 manufactured by CIBA Speciality Chemicals®), and 1.3 weight portions of sodium stearate with respect to 100 weight portions of the summation of the ultrahigh-molecular weight polyethylene and the polyethylene wax were added, and calcium carbonate (manufactured by Maruo Calcium Co. LTD.) with an average particle diameter of 0.1 μm was further added as the pore-forming agent so that its proportion to the entire volume is 36 vol %. After these materials were mixed in a power state with a Henschel mixer, the mixture was kneaded while being melted, and then filtered with a 200-mesh metal mesh to obtain a polyolefin-resin composite. This mixture was rolled using a pair of rollers having a surface temperature of 150° C. and cooled stepwise while being drawn with a winding roller different in speed from the rollers (drawing ratio (winding speed/rolling speed)=1.4), resulting in a single-layer sheet with a thickness of 29 μm. Next, a single-layer sheet with a thickness of 34 μm was prepared in a similar matter. The obtained single-layer sheets were crimped with a pair of rollers having a surface temperature of 150° C. and cooled stepwise while being drawn with a winding roller different in speed from the rollers (drawing ratio (winding speed/rolling speed)=1.4) to prepare a stacked-layer sheet with a thickness of approximately 51 μm. This sheet was dipped in hydrochloric acid (4 mol/L) including 0.5 wt % of a nonionic surfactant to remove calcium carbonate and sequentially stretched to 6.2 times at 105° C. to obtain the first layer.

### 2. Fabrication of Secondary Battery

A method for fabricating the secondary batteries including the separators of the Examples 1 and 2 and Comparative Example 1 is described below.

### 2-1. Positive Electrode

A commercially available positive electrode manufactured by applying a stack of LiNi_{0.5}Mn_{0.3}Co_{0.2}O₂/conductive material/PVDF (weight ratio of 92/5/3) on an aluminum foil was processed. Here, LiNi_{0.5}Mn_{0.3}Co_{0.2}O₂ is an active-substance layer. Specifically, the aluminum foil was cut so that a size of the positive-electrode active-substance layer is 45 mm×30 mm and that a portion with a width of 13 mm, in which the positive-electrode active-substance layer is not formed, was left in a periphery and was used as a positive electrode in the following fabrication process. A thickness, a density, and a positive-electrode capacity of the positive-electrode active-substance layer were 58 μm, 2.50 g/cm³, and 174 mAh/g, respectively.

### 2-2. Negative Electrode

A commercially available negative electrode manufactured by applying graphite/poly(styrene-co-1,3-butadiene)/carboxymethyl cellulose sodium salt (weight ratio of 98/1/1) on a copper foil was used. Here, the graphite functions as a negative-electrode active-substance layer. Specifically, the copper foil was cut so that a size of the negative-electrode active-substance layer is 50 mm×35 mm and that a portion with a width of 13 mm, in which the negative-electrode active-substance layer is not formed, was left in a periphery and was used as a negative electrode in the following fabrication process. A thickness, a density, and a negative-electrode capacity of the negative-electrode active-substance layer were 49 μm, 1.40 g/cm³, and 372 mAh/g, respectively.

### 2-3. Fabrication

The positive electrode, the separator, and the negative electrode were stacked in the order in a laminated pouch to obtain a stacked body. At this time, the positive electrode and the negative electrode were arranged so that the entire top surface of the positive-electrode active-substance layer overlaps with a main surface of the negative-electrode active-substance layer.

Next, the stacked body was arranged in an envelope-shaped housing formed by stacking an aluminum layer and a heat-seal layer, and 0.25 mL of an electrolyte solution was added into the housing. A mixed solution in which LiPF₆ was dissolved at 1.0 mol/L in a mixed solvent of ethyl methyl carbonate, diethyl carbonate, and ethylene carbonate with a volume ratio of 50:20:30 was used as the electrolyte solution. The secondary battery was fabricated by heat-sealing the housing while reducing the pressure in the housing. A designed capacity of the secondary battery was 20.5 mAh.

### 3. Evaluation

The methods for evaluating the physical properties of the separators according to the Examples 1 and 2 and the Comparative Example 1 and the performance of the secondary batteries including the separators are described below.

### 3-1. Thickness

The thickness D was measured using a High-Resolution Digital Measuring Unit manufactured by Mitsutoyo Corporation.

### 3-2. Porosity

The first layer 132 was trimmed into a square with a side length of 10 cm, and its weight W (g) was measured. The porosity (vol %) was calculated from the thickness D (μm) and the weight W (g) according to the following equation,

Porosity (vol %)=(1−(W/specific gravity)/(10×10×D/10000))×100

where the specific gravity is that of the ultrahigh-molecular weight polyethylene powder.

### 3-3. Falling-Ball Test

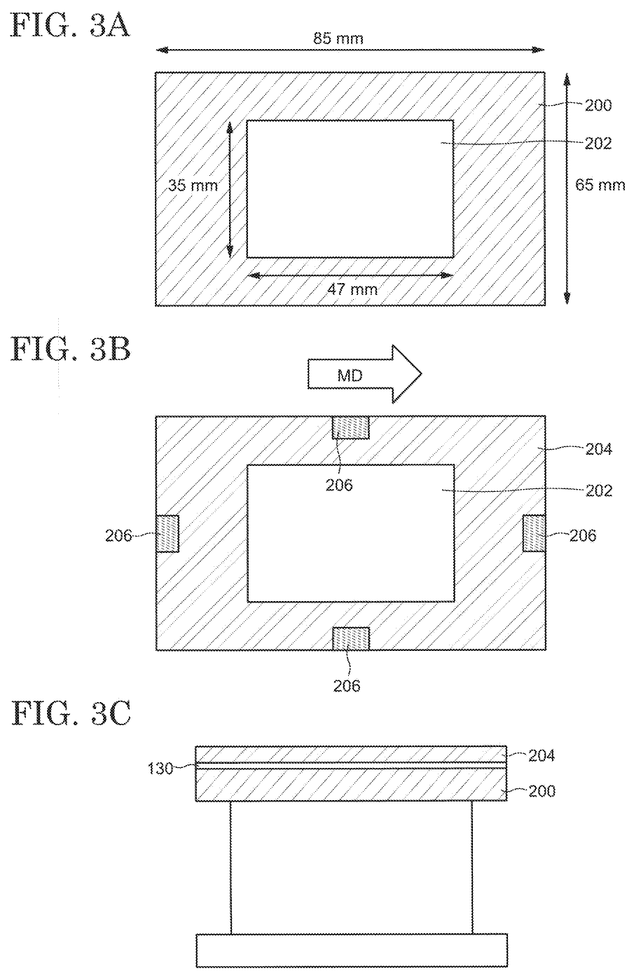

The tools used in the falling-ball test are illustrated in FIG. 3A to FIG. 3C. FIG. 3A is a top view of a frame 200 over which the separator 130 is placed, and FIG. 3B and FIG. 3C are respectively a top view and a side view of a state where the separator 130 and a SUS plate 204 are disposed over the frame 200. The frame 200 has an opening 202 of 47 mm×34 mm and has a rectangular shape of 85 nm×65 mm. The separator trimmed into a size of 85 mm×65 mm was placed over the frame 200 (FIG. 3C). At this time, the separator was placed so that the MD of the separator 130 is parallel to the longitudinal sides of the opening 202. Next, the SUS plate 204 having the same shape as the frame 200 was placed over the separator 130, and the frame 200 and the SUS plate 204 were fixed at around the center of each side using clamps (non-twist clamp) 206 as shown in FIG. 3B and FIG. 3C. As illustrated in FIG. 3C, the separator 130 was sandwiched by the frame 200 and the SUS plate 204.

In this state, a mirror-surface ball having a diameter of 14.3 mm, a weight of 11.9 g, and a surface roughness Ra of 0.016 μm was allowed to freely fall from over the opening, and then whether a break (split) occurred in the separator 130 was confirmed. This operation was carried out plural times, where a new separator 130 was used in every falling-ball test. Note that the surface roughness (Ra) of the ball was measured with a non-contact surface profiler system (VertScan™ 2.0 R5500GML manufactured by Ryoka Systems Inc.) under the following conditions.

Object lens: magnifying power of 5 (Michelson type)

Intermediate lens: magnifying power of 1 (Michelson type)

Wavelength filter: 530 nm

CCD camera: ⅓ inch

Measuring mode: wave

Data correction: spherical approximation with a radius of 7.15 mm

The height of the ball subjected to the free fall in the first falling-ball test, that is, the distance between the ball immediately prior to the free fall and the separator 130 was defined as h1. In the case where a break was observed in the separator 130 as a result of the first falling-ball test, the height of the ball h2 in the second falling-ball test was changed to (h1−5 cm), while the height of the ball h2 in the second falling-ball test was changed to (h1+5 cm) in the case where no break was observed in the separator 130. The falling-ball test was repeated by changing the height of the ball in this way. Namely, the height of the ball hk+1 in the (k+1)th falling-ball test was changed to (hk−5 cm) in the case where a break was observed in the separator 130 as an evaluation result of the kth (k is an integral equal to or larger than 1) falling-ball test performed by employing a distance hk between the separator 130 and the ball, while the height of the ball hk+1 was changed to (hk+5 cm) in the (k+1)th falling-ball test in the case where no break was observed. The falling-ball test was repeated until the number of the falling-ball tests in which the break was observed and the number of the falling-ball tests in which no break was observed each reached five, and the lowest height of the ball in the falling-ball test in which the break was observed was determined as the minimum height.

### 3-4. Tearing Strength T

As described below, the tearing strength T was measured with the Elmendorf tearing method. The separators prepared in the Examples 1 and 2 and the Comparative Example 1 were cut in the TD and processed into the rectangle regulated by the JIS Regulation. The swing angle of the pendulum was set at 68.4°, and the tearing direction in the measurement was arranged in the TD of the separators 130. The measurement was conducted with a Digital Elmendorf Type Tearing Tester (model SA-WP manufactured by Toyo Seiki Seisaku-sho, Ltd). Each test was carried out in a state where 4 to 8 separators 130 are stacked, and the number of measurements was 5. The obtained measurement results were processed as described in the First Embodiment to calculate the tearing strength T per 1 μm thickness of the separator 130.

### 3-5. Tensile Elongation E

As described below, the tensile elongation E was measured with the rectangular method. The separators prepared in the Example 1 and 2 and the Comparative Example 1 were cut in the MD and processed to the shape regulated by the JIS Regulation JIS K 7128-3. The separators 130 were elongated at an elongating rate of 200 mm/min so that the tearing direction was in the TD. Each separator 130 was subjected to the measurement five times using the Universal Testing System (model 5582 manufactured by Instron), and the load-elongation curves were obtained from the measurement results. The tensile elongation E was calculated using the obtained load-elongation curves according to the method described in the First Embodiment.

### 3-6. Trimming Processability

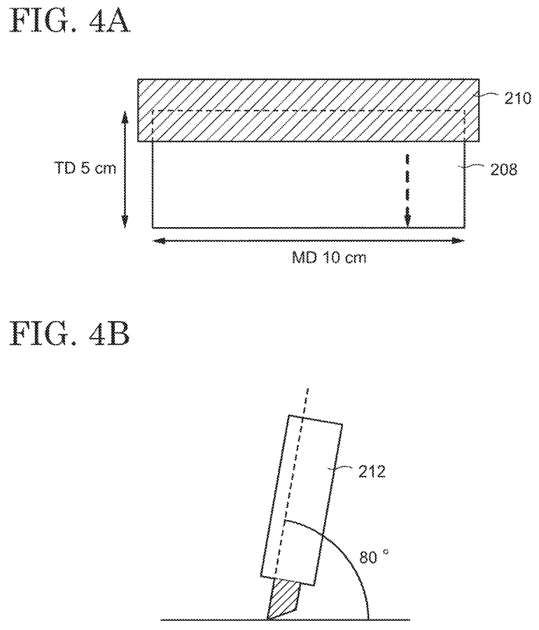

FIG. 4A and FIG. 4B show an evaluation method of the trimming processability. As illustrated in FIG. 4A, one longitudinal side of the separator 130 trimmed to have the MD of 10 cm and TD of 5 cm was fixed with a tape 210. Next, as shown in FIG. 4B, 3 cm of the separator 130 was cut by moving a cutter knife 212 parallel to the TD at a rate of approximately 8 cm/s while being maintained at 80° with respect to the horizontal direction. After that, the cutting state was evaluated (see a dotted arrow in the drawing). A case where a split in an unintended direction (MD) was observed in the cut portion was evaluated as “−”, while a case where no split was observed in an unintended direction was evaluated as “+”. A model A300 manufactured by NT Incorporated was used as the cutter knife 212, and a model Ma-44N was used as a cutting mat. The blade was replaced in every test, and a model BA-160 manufactured by NT Incorporated was used as a replaceable blade.

### 3-7. Pin-Extracting Test

The separator 130 was cut into a tape shape into the MD×TD of 62 mm×30 cm, and one terminal of the MD was attached to a scale weight of 300 g, while the other terminal was wound on a stainless-steel scale (model 13131 manufactured by Shinwa Rules Co., Ltd.) five times. The stainless-steel scale has a bent knob at a terminal in the longitudinal direction, and the separator 130 was wound so that the TD of the separator and the longitudinal direction of the stainless-steel scale are parallel to each other. After that, the stainless-steel scale was extracted toward the side on which the bent knob is formed at a rate of approximately 8 cm/s, and a feeling of easiness of extraction (extraction feeling) was evaluated. Specifically, a case where the scale was smoothly extracted without feeling any resistance was evaluated as “+”, a case where a slight resistance was felt was evaluated as “±”, and a case where a resistance was sensed and a hardness of extraction was felt was evaluated as “−”.

The width of the portion of the TD of the separator 130 wound five times was measured with a caliper before and after extracting the stainless-steel scale, and a variation (mm) therebetween was calculated. This variation is an elongation of the separator in the extraction direction when the winding start of the separator moves in the extraction direction of the stainless-steel scale due to the friction between the stainless-steel scale and the separator 130 and the separator deforms into a helical shape.

### 3-8. Pin-Extracting Resistance

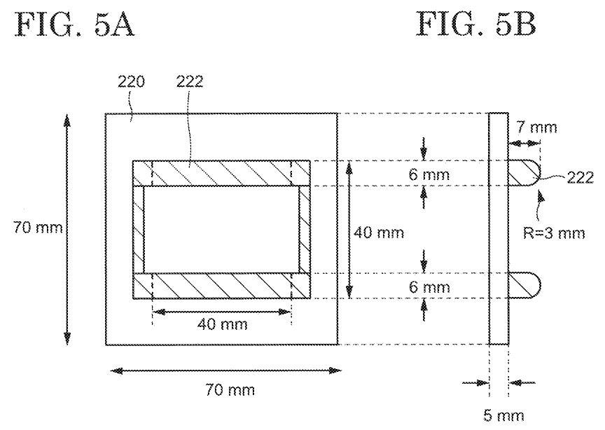

FIG. 5A and FIG. 5B are drawings showing a sledge 220 for measuring a pin-extracting resistance indicative of a magnitude of friction between the surface of the separator 130 and other members. FIG. 5A and FIG. 5B are respectively a bottom view and side view of the sledge. As shown in FIG. 5A, the sledge 220 has two protrusions 222 having a tip curvature of 3 mm on a bottom surface thereof. The protrusions are arranged parallel to each other with an interval of 28 mm.

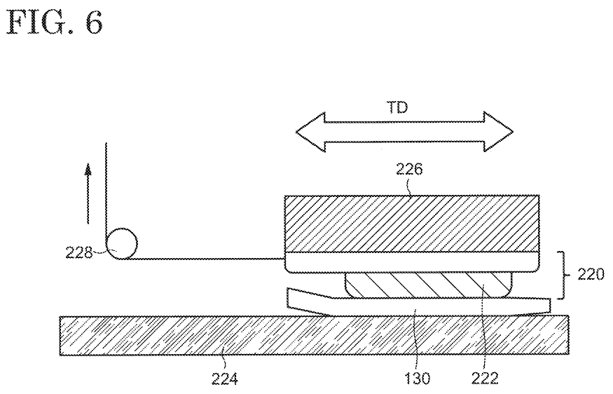

As illustrated in FIG. 6, the separator 130 was cut so as to have the TD of 6 cm and the MD of 5 cm, and the separator 130 was stuck to the protrusions 222 with a tape so that the TD of the separator 130 matches the direction of the protrusions 222. In the case where the separator 130 has a porous layer, the separator 130 was arranged so that the porous layer is in contact with the sledge 220.

Next, the sledge 220 having a lower surface stuck with the separator 130 was placed on a plate 224 processed with a fluorine resin (a plate subjected to SILVERSTONE™ processing). A scale weight 226 was disposed on the sledge 220. A total weight of the scale weight 226 and the sledge 220 was 1800 g. As shown in FIG. 6, the separator 130 was arranged between the sledge 220 and the plate 224. The SILVERSTONE processing was performed on a plate of high-speed steel SKH51 in HAKUSUI CO., LTD. The thickness of the SILVERSTONE processing was 20 to 30 μm, and the surface roughness Ra measured with a HANDYSURF™ was 0.8 μm.

A string (Super Cast PE Tou No. 2 manufactured by SUNLINE CO, LTD.) was attached to the sledge 220, and the sledge 220 was pulled at a rate of 20 mm/min using an Autograph (model AG-I manufactured by Shimadzu Corporation) via a pully 228 to measure a tension thereof. This tension indicates the friction between the plate 224 and the separator 130. The pin-extracting resistance was calculated according to the following equation by using the tension F (N) at the 10 mm advanced point from the starting point of the measurement.

Pin-extracting resistance=F×1000/(9.80665/1800)

### 3-9. Test for Determining Number of Voltage Resistance Defects

The dielectric-breakdown resistance was evaluated, on the basis of the number of voltage resistance defects, by performing the following voltage resistance test on the separators obtained in the Examples and the Comparative Example using the Insulation Resistance Tester TOS-9201 manufactured by Kikusui Electronics Corporation.

(i) The separator cut into a size of 13 cm×13 cm was sandwiched between an upper columnar electrode (φ25 mm) and a lower columnar electrode (φ75 mm).

(ii) A voltage is applied between the electrodes while increasing the voltage to 800 V at a voltage-increase rate of 40 V/s, and then this voltage (800 V) was maintained for 60 seconds.

(iii) The voltage was applied to 10 positions of the same separator with the same method as those described in the steps (i) and (ii).

(iv) After the voltage resistance test described in the step (iii), the separator was placed on a thin-type trace stage equipped with a light source, and photo images were captured from a 20 to 30 cm height over the separator using a digital steel camera in a 4:3 steel-image mode (5M, 2,592×1,944), while irradiating the separator with light from a back surface, so that the 10 measuring points are entirely included in the image. Cyber-Shot DSC-W730 having approximately 16,100,000 pixels (manufactured by Sony Corporation) was used as the digital steel camera, and Treviewer A4-100 (manufactured by Trytec Japan Co., LTD) was used as the thin-type trace stage.

(v) The image data captured in the step (iv) was analyzed with a free software ImageJ provided by the National Institutes of Health (NIH) to determine the number of voltage resistance defects and calculate the number (defect number) of the defect points. A case where the number of defect points is less than 10 was evaluated as “+”, a case where the number of defect points is equal to or more than 10 and less than 30 was evaluated as “±”, and a case where the number of defect points is more than 30 was evaluated as “−”. Note that a plurality of defect points may be generated in every measurement of the step (ii).

### 2. Properties of Separator and Secondary Battery

The properties of the separators obtained in the Examples 1 and 2 and the Comparative Example 1 and the performance of the secondary batteries including the separators are shown in Table 1.

TABLE 1
Properties of separators and secondary batteries

| | Separator | | | | | | | | | Secondary battery |
|---|---|---|---|---|---|---|---|---|---|---|
| | | | Minimum | | | | Pin-extraction test | | | Test for |
| | First layer | | height | Tearing | Tensile | | | Variation in | Pin- | determining defect |
| | Thickness | | hₘᵢₙ | strength T | elongation E | Trimming | Extraction | width after | extraction | number to |
| | (mm) | Porosity | (cm) | (mN/mm) | (mm) | processability | feeling | extraction | resistance | withstand voltage |
| Example 1 | 11.1 | 37 | 65 | 2.7 | 0.5 | + | + | 0.03 | 0.091 | + |
| Example 2 | 16.4 | 53 | 115 | 1.9 | 0.5 | + | + | 0.03 | 0.078 | ± |
| Comparable | 16.7 | 65 | 35 | 1.4 | 0.6 | + | − | 0.19 | 0.169 | − |
| Example 1 | | | | | | | | | | |

As shown in Table 1, it was confirmed that the minimum heights hₘᵢₙ of the separators 130 of the Examples 1 and 2 are equal to or more than 50 cm and equal to or less than 150 cm. On the other hand, the minimum height of the separator 130 of the Comparative Example 1 is as low as 35 cm. The separators of the Examples 1 and 2 exhibit the tearing strengths T equal to or more than 1.5 mN/μm and the tensile elongations E equal to or longer than 0.5 mm, while the separator 130 of the Comparative Example does not simultaneously satisfy the two properties regarding the tearing strength T and the tensile elongation E.

The separators of Examples 1 and 2, which simultaneously satisfy the properties that the minimum height hₘᵢₙ is equal to or more than 50 cm and equal to or less than 150 cm, the tearing strength T is equal to or more than 1.5 mN/μm, and the tensile elongation E is equal to or longer than 0.5 mm, have excellent trimming processability and a high surface slip property. Therefore, friction with other members is small, which leads to a low pin-extracting resistance, a pin-extraction feeling, and a small variation after pin extraction. The pin-extraction resistance relates to the friction of the separator 130 and indicates an easiness of pin extraction in fabricating a wound secondary battery. Hence, a decrease in the pin-extraction resistance improves the slip property with respect to the pin, which contributes to a reduction in a production takt time of a secondary battery. In contrast, the separator of the Comparative Example 1 has a large pin-extracting resistance and shows a large variation after the pin extraction. This means large friction with other members causing a decrease in yield.

It can be understood from Table 1 that the separators 130 of Examples 1 and 2 demonstrate a small voltage resistance defect number in the voltage resistance test and possess an excellent dielectric-breakdown resistance. Hence, the use of the separator 130 including the first layer 132 according to an embodiment of the present invention enables high-yield production of a highly safe and reliable secondary battery at low cost.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements is included in the scope of the present invention as long as it possesses the concept of the present invention.

It is understood that another effect different from that provided by the modes of the aforementioned embodiments is achieved by the present invention if the effect is obvious from the description in the specification or readily conceived by persons ordinarily skilled in the art.

### EXPLANATION OF REFERENCE NUMERAL

100: Secondary battery, 110: Positive electrode, 112: Positive-electrode current collector, 114: Positive-electrode active-substance layer, 120: Negative electrode, 122: Negative-electrode current collector, 124: Negative-electrode active-substance layer, 130: Separator, 132: First layer, 134: Porous layer, 140: Electrolyte solution, 200: Frame, 202: Opening, 204: SUS Plate, 206: Clamp, 210: Tape, 232: Cutter Knife, 220: Sledge, 222: Protrusion, 224: Plate, 228: Pully,

1. A separator comprising:
a first layer consisting of a porous polyolefin,
wherein the first layer exhibits a minimum height equal to or more than 50 cm and equal to or less than 150 cm when a ball having a diameter of 14.3 mm and a weight of 11.9 g located over the first layer is allowed to free fall causing a split in the first layer,
wherein a tearing strength of the first layer in a width direction, measured with an Elmendorf tearing method, is equal to or more than 1.5 mN/μm, and
wherein a tensile elongation of the first layer is equal to or longer than 0.5 mm until a load decreases to 25% of a maximum load in a load-elongation curve in machine direction measured by a rectangular tearing method.

2. The separator according to claim 1,
wherein a thickness of the separator is equal to or larger than 4 μm and equal to or smaller than 20 μm.

3. The separator according to claim 1,
wherein a porosity of the separator is equal to or more than 20 vol % and equal to or less than 55 vol %.

4. The separator according to claim 1, further comprising a porous layer over the first layer.

5. The separator according to claim 1, further comprising a pair of porous layers sandwiching the first layer.

6. A secondary battery comprising the separator according to claim 1.
